(19) United States
(12) Patent Application Publication
(10) Pub. No.: US 2020/0028268 A1
(43) Pub. Date: Jan. 23, 2020

(54) COMBINED TEM-HORN ANTENNA

(71) Applicant: The Regents of the University of Colorado, a body corporate, Denver, CO (US)

(72) Inventors: Mohamed Ali Elmansouri, Boulder, CO (US); Dejan S. Filipovic, Lafayette, CO (US)

(21) Appl. No.: 16/057,805

(22) Filed: Aug. 7, 2018

Related U.S. Application Data
(60) Provisional application No. 62/542,111, filed on Aug. 7, 2017.

(51) Int. Cl. H01Q 13/02; H01Q 13/08

(52) U.S. Cl. CPC H01Q 13/0233; H01Q 13/085

(57) ABSTRACT

Various implementations of combined antenna are provided. In one implementation, for example, a combined antenna comprises a transverse electromagnetic (TEM) horn antenna element and a loop antenna element coupled to the TEM horn antenna element, wherein the loop antenna element comprises at least one slot disposed in the loop antenna element.

### CROSS-REFERENCE TO RELATED APPLICATIONS

This application claims the benefit of U.S. provisional application No. 62/542,111, filed Aug. 7, 2017, which is hereby incorporated by reference in its entirety including all appendices thereto as though fully set forth herein.

This invention was made with government support under Award Nos. N00014-13-1-0537, N00014-16-C-2001, and N00173-17-D-2006 awarded by the Office of Naval Research. The government has certain rights in the invention.

### BACKGROUND

### a. Field

The present disclosure relates to combined TEM horn-loop antennas.

### b. Background

Combined antennas have been developed but often lack wideband performance.

### BRIEF SUMMARY

In one example implementation, a TEM horn-loop antenna combines a TEM horn and a metallic loop routed along the back of the antenna. One or more slots, such as but not limited to crescent, triangular, rectangular, oval or other shaped slots, and plates, such as but not limited to bow-tie or other shaped plates, are added along the loop. In some applications, these may simultaneously lower the turn-on frequency, improve match and gain at the low frequencies without deteriorating performance at higher frequencies

In some implementations, compact antennas and arrays are provided. For example, compact antennas and arrays are adapted to operate over subhyperband bandwidths under the conditions of high peak power and low time and frequency dispersion. In one implementation, for example, combined transverse electromagnetic (TEM) and loop antenna elements are provided. Spherical modes expansion (SME) can be used to aid in tuning a combined antenna TE (i.e., loop antenna) and TM (i.e., TEM horn) modes. Constructive combination of the two modes below the horn's turn on frequency can allot miniaturization of the antenna and improve its gain. Tuning of desired modes (magnitude and phase) can be achieved by modifying the loop geometry. The antenna's geometry also supports constructive interference between higher order spherical modes and maintaining quality performance over an operating bandwidth.

The foregoing and other aspects, features, details, utilities, and advantages of the present invention will be apparent from reading the following description and claims, and from reviewing the accompanying drawings.

### BRIEF DESCRIPTION OF THE DRAWINGS

FIG. 1 shows a perspective view of an example combined (K) antenna.

FIG. 2 is a perspective view of one implementation of a combined TEM horn-loop antenna.

FIGS. 3A through 3D show, respectively, a front view of another example implementation of a combined TEM horn-loop antenna (FIG. 3A), a top view of the combined TEM horn-loop antenna (FIG. 3B), a isometric view of the combined TEM horn-loop antenna (FIG. 3C) and a side view of the combined TEM horn-loop antenna (FIG. 3D).

FIGS. 4A and 4B show the signal input components of FIG. 2 and FIGS. 3A-3D, respectively.

FIG. 5 shows the effect of individual features of the example combined antennas on the spherical mode spectrum of the antennas.

FIG. 6 shows example implementations of a combined antenna implementation integrated with a ground plane that enables horizon radiation.

FIG. 7 shows an example implementation of a circular array of half-cut or full combined antennas.

FIG. 8 shows another example implementation of a linear array of half-cut or full combined antennas.

FIG. 9A shows an example implementation of a flush-mountable lossless combined antenna in which the combined antenna is flush mounted in a cavity.

FIG. 9B shows additional views of the flush-mountable lossless combined antenna shown in FIG. 9A showing further detail of the combined antenna element components.

FIG. 10 shows an example implementation of a flush-mountable lossless combined array in which two or more individual combined antennas are formed in a cavity as described with respect to FIGS. 9A and 9B.

FIG. 11A shows example implementations of compact flush-mountable low-loss combined antenna disposed in an absorptive cavity with radome for airborne decoy applications.

FIGS. 11B and 11C show example implementations of the combined antenna disposed within the absorptive cavity to form the individual compact flush-mountable low-loss combined antenna.

FIGS. 12A and 12B show example implementations of compact combined antennas disposed in lossless cavity with radome.

FIG. 12C shows a graph of the Voltage Standing Wave Ratio (VSWR) performance for a compact combined antenna in a lossless cavity with radome for airborne decoy applications.

FIG. 13 shows an example compact resistively-loaded combined antenna with a zipper balun in an absorptive cavity that may be used in applications such as an amplitude-only direction finding application.

FIG. 14 shows an example implementation of a dual-polarized TEM horn combined antenna.

FIG. 15 shows a schematic diagram of an example eight-element combined antenna array (that may be free-standing or inside cavity) for simultaneous transmit and receive (STAR) applications.

FIGS. 16A and 16B show example implementations of sequentially rotated array of four combined antennas combined with a four-arm sinuous antenna at the center of the array to realize a compact, wideband, and dual-polarized STAR antenna system.

FIGS. 17A and 17B show another example implementation of a compact flush-mountable low-loss combined antenna in an absorptive cavity with radome for airborne decoy applications.

FIGS. 18A and 18B show another example implementation of a compact antenna in a loss-less cavity with radome for airborne decoy applications

### DETAILED DESCRIPTION

In some implementations, compact antennas and arrays are provided. For example, compact antennas and arrays are adapted to operate over subhyperband bandwidths under the conditions of high peak power and low time and frequency dispersion. In one implementation, for example, combined transverse electromagnetic (TEM) and loop antenna elements are provided. Spherical modes expansion (SME) can be used to aid in tuning a combined antenna TE (i.e., loop antenna) and TM (i.e., TEM horn) modes. Constructive combination of the two modes below the horn's turn on frequency can allot miniaturization of the antenna and improve its gain. Tuning of desired modes (magnitude and phase) can be achieved by modifying the loop geometry. The antenna's geometry also supports constructive interference between higher order spherical modes and maintaining quality performance over an operating bandwidth. Example analyses of antenna design is described at length in U.S. provisional patent application No. 62/542,111, filed Aug. 7, 2017, previously incorporated by reference herein. In addition, combined TEM horn and loop antennas are used to demonstrate the feasibility to tune modes over wide bandwidths to achieve desired performance characteristics by modifying the horn and/or loop geometry and using only a single feed. As used herein, a composite of a TEM horn and loop is referred to as a “composite antenna.” In various implementations, the combined antenna can be excited using a single source at an input of a transmission line.

Perturbation slots added to various locations of the combined antennas (e.g., elliptical slots such as half-ellipse and/or crescent slots) to bottom and/or top plates of the combined antenna can be used to tune the excitation of a fundamental TE mode at a low frequency end (e.g., to improve impedance and gain). Further, in some implementations, a vertical extension may be added at the TEM horn opening to improve the voltage standing wave ratio (VSWR) of the combined antenna.

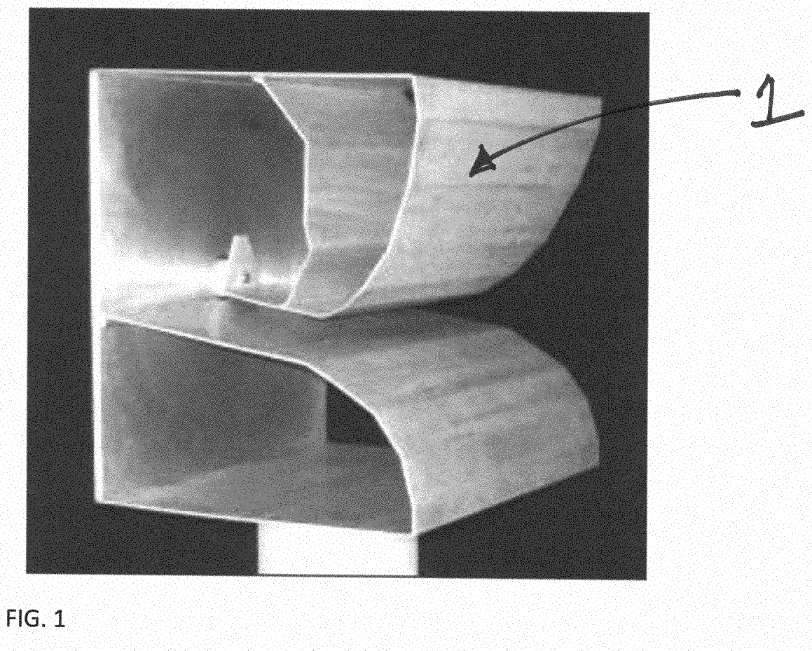

FIG. 1 shows a perspective view of an example combined (K) antenna 1.

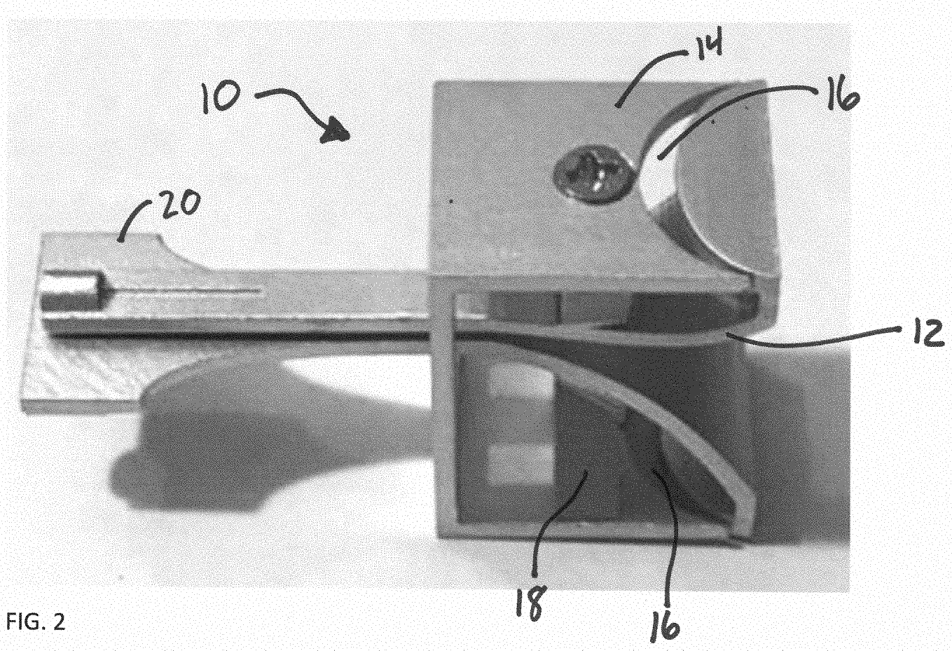

FIG. 2 is a perspective view of one implementation of a combined TEM horn-loop antenna 10. The combined antenna 10 comprises a transverse electromagnetic (TEM) horn antenna element 12 and a conductive loop antenna element 16 routed along a rear side of the antenna. The TEM horn antenna element 12 and the conductive loop antenna element 14. Elliptical slots 16, such as the crescent slots 16 and bow-tie shaped plates 18 are added along the loop to simultaneously lower the turn-on frequency, improve match and gain at the low frequencies without deteriorating performance at higher frequencies. See, e.g., M. Elmansouri and D. S. Filipovic, “Miniaturization of TEM horn using spherical modes engineering,” IEEE Transactions on Antennas and Propagation, vol. 64, issue 12, pp. 5064-5073, December 2016, which is incorporated by reference herein in its entirety. Further, the combined antenna 10 comprises a microstrip feed 20 disposed at a bottom of the combined antenna 10.

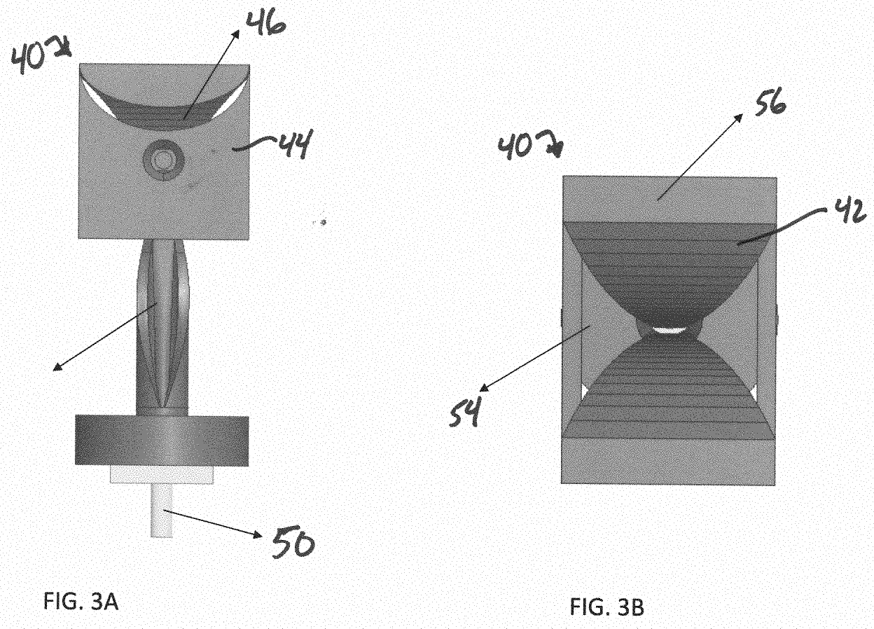

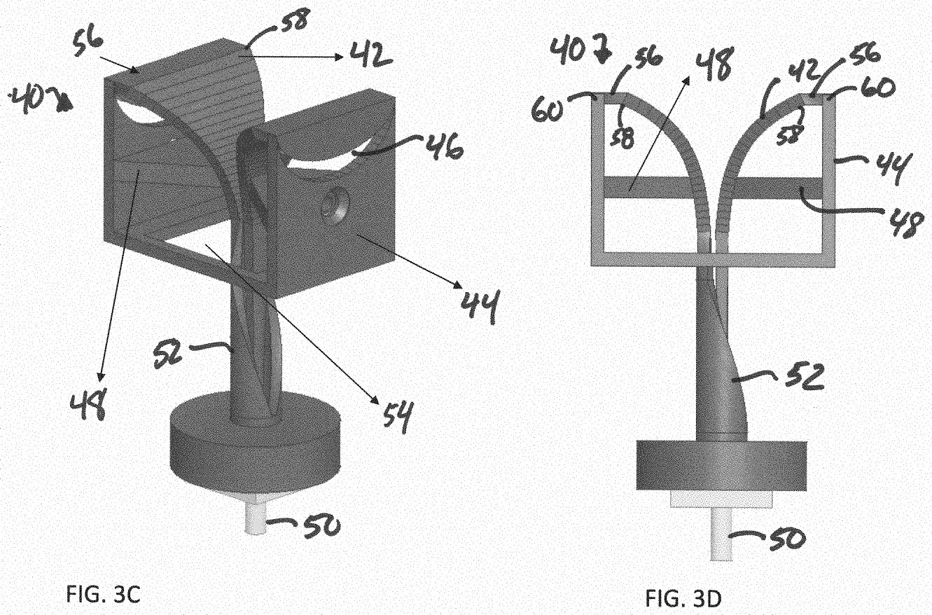

FIGS. 3A through 3D show, respectively, a front view of another example implementation of a combined TEM horn-loop antenna 40 (FIG. 3A), a top view of the combined TEM horn-loop antenna 40 (FIG. 3B), a isometric view of the combined TEM horn-loop antenna 40 (FIG. 3C) and a side view of the combined TEM horn-loop antenna 40 (FIG. 3D). In this particular implementation, for example, FIGS. 3A, 3C and 3D show that the antenna 40 comprises a TEM horn antenna element 42 and a metallic loop antenna element 44. One or more elliptical slots 46, such as the crescent slots 46, are disposed in the conductive/metallic loop 44 of the combined antenna 40. Bow-tie insert plates 48 are also disposed as shown between the outer loop element 44 and the inner TEM horn antenna element 46 extending from an outer edge of the TEM horn antenna element 42 to an inner edge of the outer loop antenna element 44. A back slot 54 is further disposed at the bottom of the outer loop antenna element where the TEM horn antenna element and/or zipper balun extend through the outer loop element 44. In this particular implementation, a coaxial connector 50 and zipper balun 52 collectively comprise a signal input component and are disposed at a bottom of the combined antenna as shown in FIGS. 3A, 3C and 3D for coupling to an excitation signal. An aperture extension 56 is further disposed between distal ends 58 of the TEM horn antenna element 42 and distal ends 60 of the outer loop antenna element 44.

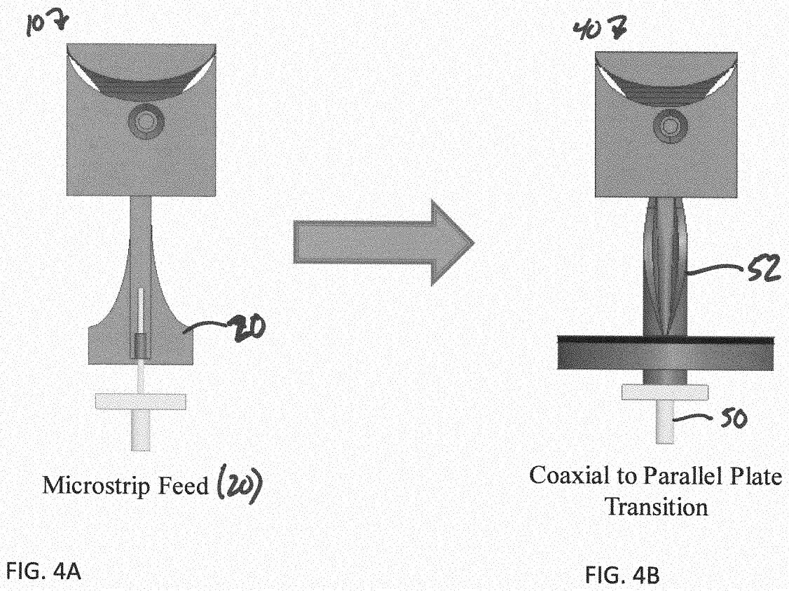

FIGS. 4A and 4B show the signal input components of FIG. 2 and FIGS. 3A-3D, respectively, showing a enlarged view of the microstrip feed 20 (microstrip to parallel strip line) of the combined antenna 10 shown in FIG. 2 and the zipper balun 52 (coaxial parallel plate line transition) shown in the combined antenna shown in FIGS. 3A-3D.

The combined antennas 10 and 20, for example, have elliptical slots (e.g., crescent slots or ellipse slots) in both loop arms of the antennas. The slots may be designed and added to tune the fundamental TE and TM spherical modes of the antenna and, in doing so, achieve the desired combination such that forward and backward gains are increased and decreased, respectively. The combined antennas 10 and 20 also (in the particular examples) each include two bowtie-shaped plates symmetrically inserted between the outer edge of the TEM horn antenna element and an inner edge of the loop arms. The plates, for example, may enable coherent superposition of higher order modes over the wide bandwidth. Further, the combined antennas 10 and 20 have extensions added to an aperture of the TEM horn to provide smooth transition from the horn to the loop for traveling wave currents that reach the horn aperture. The combined antennas 10 and 20 also may have a slot added to the back of the loops to improve front-to-back ratio (F/B) of the antennas. The combined antennas 10 and 20 further include different balun (balanced to unbalanced) comprised either of microstrip to stripline transition or zipper balun, whereas the K antenna (FIG. 1) is directly connectorized. The combined antennas 10 and 20 may also be significantly smaller (e.g., about 20-40% smaller than the K antenna, about 40% smaller than the K antenna).

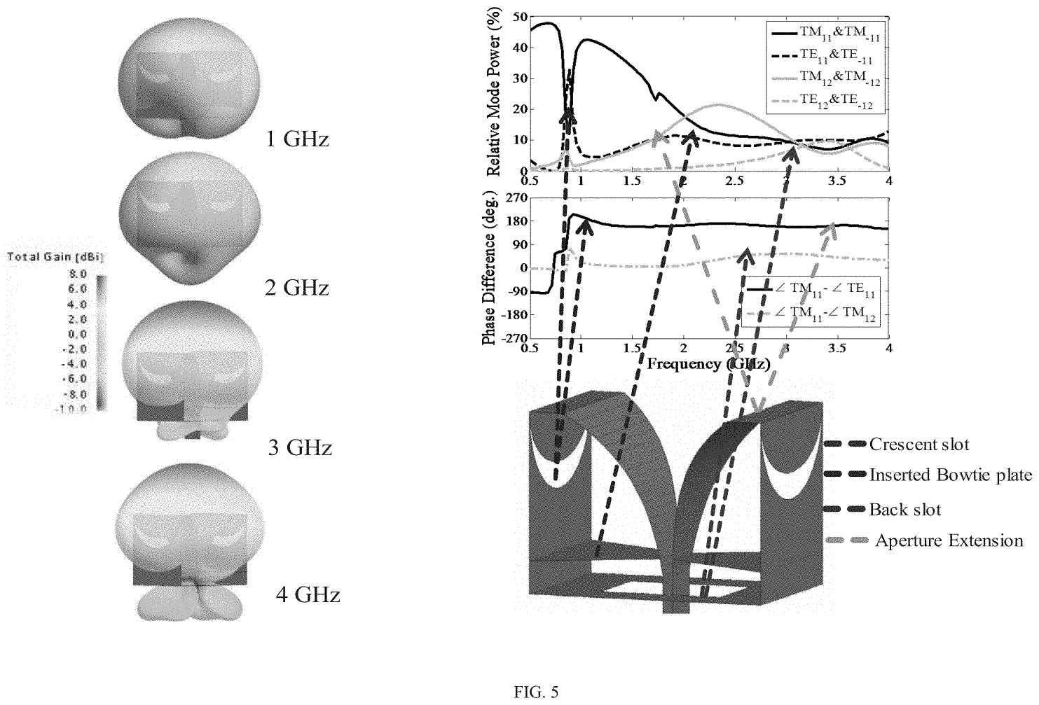

FIG. 5 shows the effect of individual features of the example combined antennas 10, 20 on the spherical mode spectrum of the antennas 10, 20. Specifically, the performance of the combined antennas 10, 20 have better impedance match, higher gain and F/B than the K antenna shown in FIG. 1. Also, the combined antennas 10, 20 provide more symmetric and consistent radiation patterns. See, e.g., U.S. provisional patent application No. 62/542,111, filed Aug. 7, 2017, previously incorporated by reference herein.

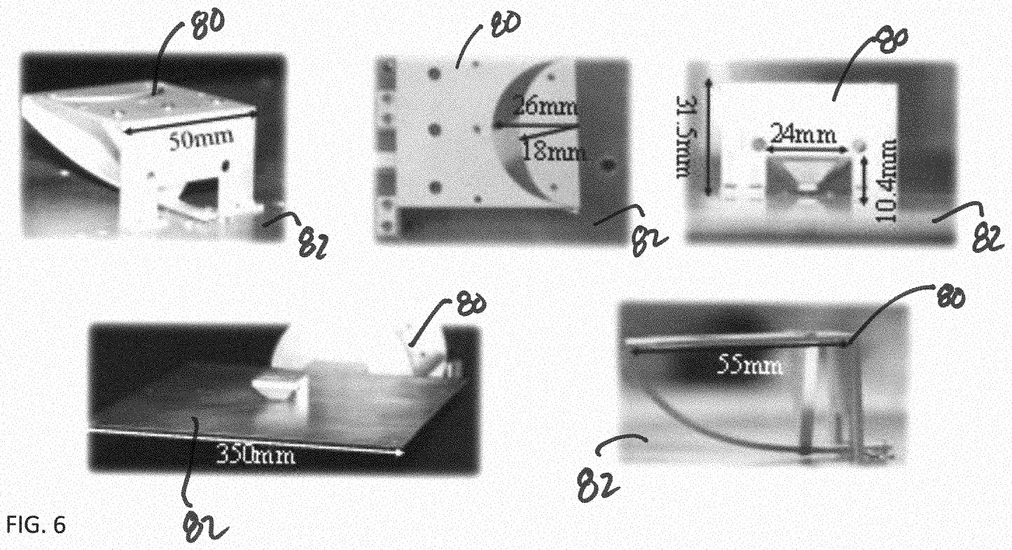

FIG. 6 shows example implementations of a combined antenna 80 implementation integrated with a ground plane that enables horizon radiation. The particular implementations shown in FIG. 6, for example, include a decade bandwidth half-cut combined antenna 80 integrated with a ground plane 82. The integration of the ground plane with the combined antenna 80 enables horizon radiation. The combined antenna 80 has a low profile and simple feed, and can be designed to handle high CW and peak power. The resulting combined antenna has low dispersion characteristics making it excellent candidate for various directed applications as well as conventional wireless communications systems. See, e.g., M. Elmansouri and D. S. Filipovic, “Miniaturization of TEM horn using spherical modes engineering,” IEEE Transactions on Antennas and Propagation, vol. 64, issue 12, pp. 5064-5073, December 2016, previously incorporated by reference.

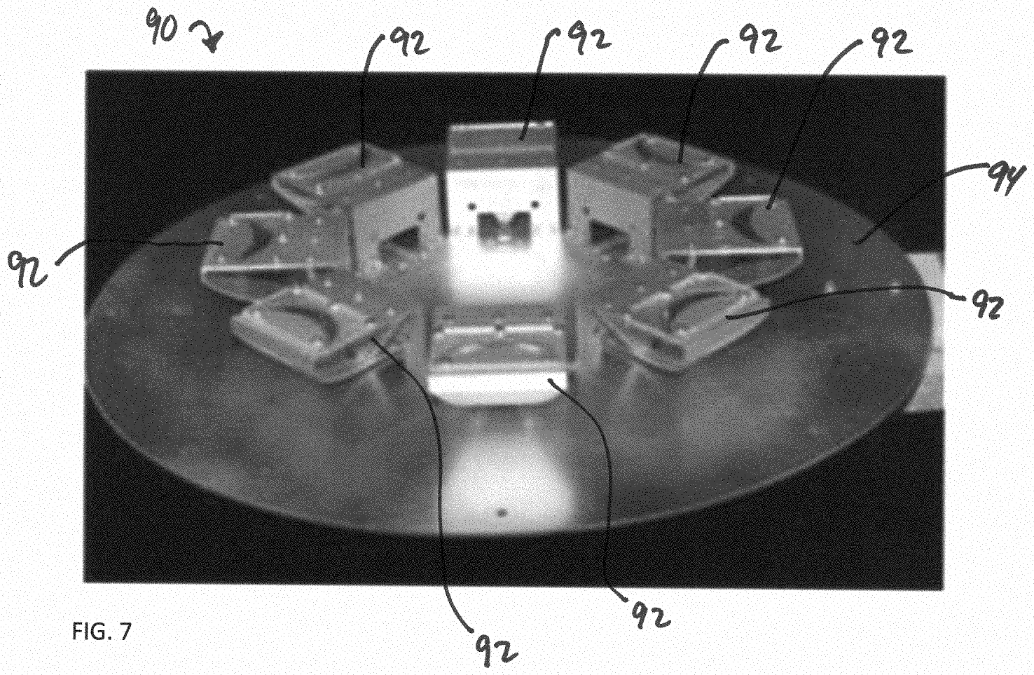

FIG. 7 shows an example implementation of a circular array 90 of half-cut or full combined antennas 92. The circular array 90 comprises a plurality of combined antennas 92 (eight in the example shown in FIG. 7) arranged in a generally circular configuration (e.g., integrated with a common ground plane 94). The resulting array 90, for example, may be useful for direction finding systems and omnidirectional/directional time- and frequency-domain radiation. See, e.g., M. Elmansouri, J. Ha, and D. S. Filipovic, “Ultrawideband TEM horn circular array,” IEEE Transactions on Antennas and Propagation, vol. 65, no. 3, pp. 1374-1379, March 2017, which is incorporated by reference herein in its entirety.

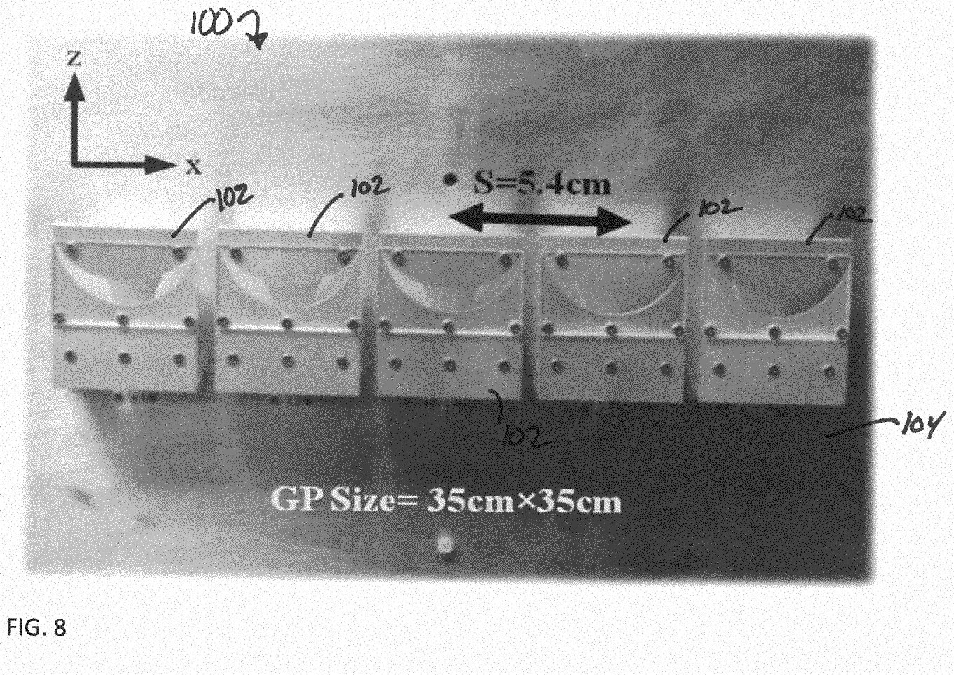

FIG. 8 shows another example implementation of a linear array 100 of half-cut or full combined antennas 102. In this particular example implementation, for example, a linear array 100 comprises a plurality of combined antennas 102 (five combined antennas in the example shown in FIG. 8) arranged in a generally linear array 100 (e.g., integrated with a common ground plane 104). The resulting array, for example, may be useful for applications such as time-domain scanning and high power transient radiation. See, e.g., M. Elmansouri and D. S. Filipovic, “Ultrawideband flush-mounted antenna,” IEEE Antennas and Wireless Propagation Letters, Accepted (Doi: 10.1109/LAWP.2017.2690962) (available at ieeexplore.ieee.org/stamp/stamp.jsp?tp=&arnumber=8221842), which is incorporated by reference herein in its entirety.

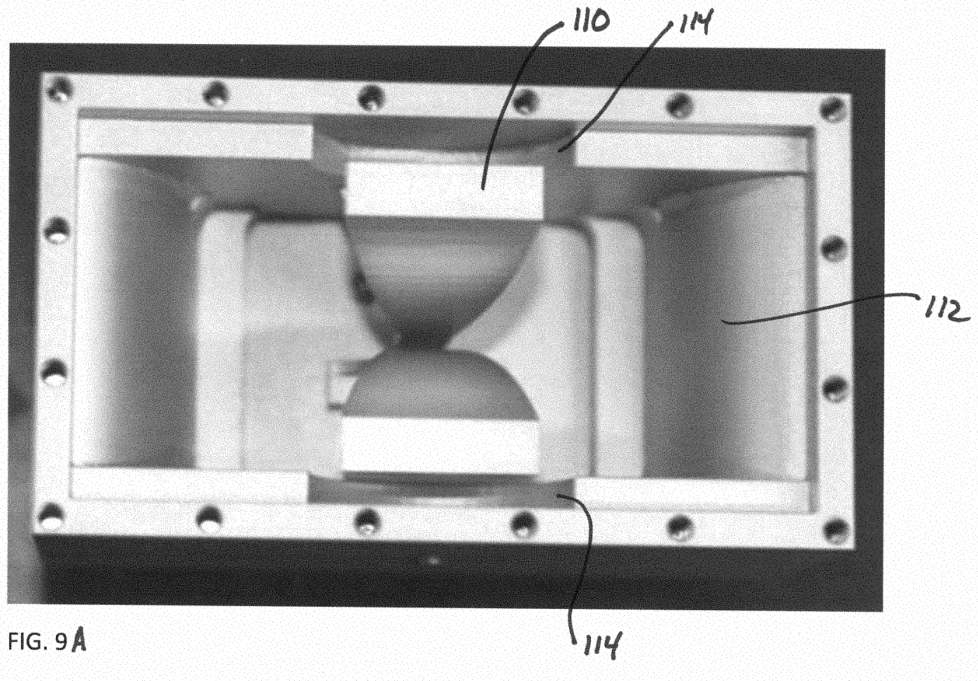

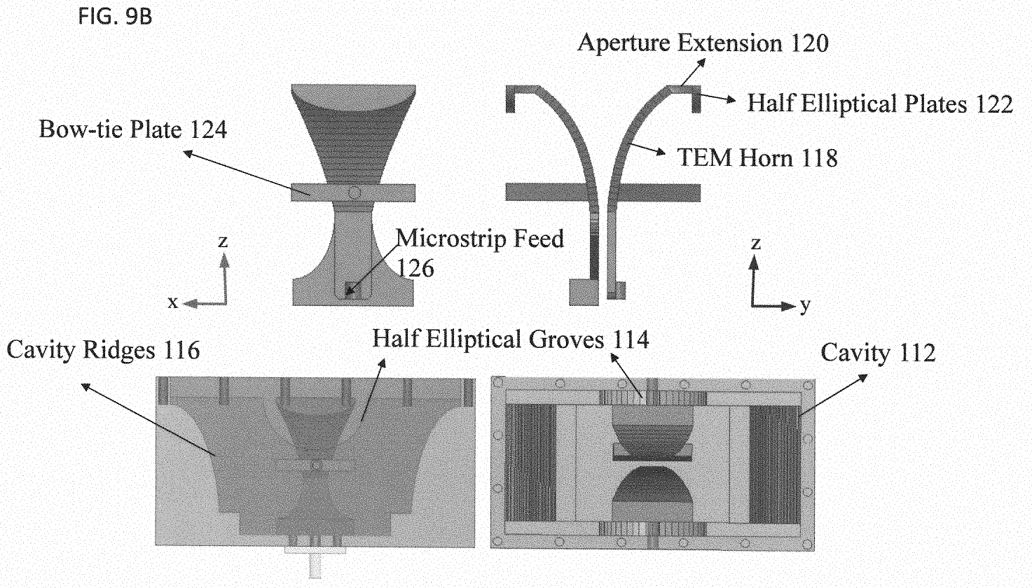

FIG. 9A shows an example implementation of a flush-mountable lossless combined antenna 110 in which the combined antenna 110 is flush mounted in a cavity 112. The cavity, in this implementation comprises a pair of half-elliptical grooves 114 each disposed opposite a half elliptical plate 116 disposed on an outer edge of the combined antenna 110 and, collectively, the grooves 114 and plates 116 form the outer loop antenna element of the combined antenna 110.

FIG. 9B shows additional views of the flush-mountable lossless combined antenna 110 shown in FIG. 9A showing further detail of the combined antenna element components. The TEM horn antenna element 118 is mounted to a microstrip feed 126 and outer bow-tie plates 124 extend from an outer surface of the TEM horn antenna element 118 to the cavity 112 surface below the grooves 114. An aperture extension 120 extends from each distal end of the TEM horn antenna element 118 and connects the TEM horn antenna element 118 to the grooves 114 via a pair of half elliptical plates 122 to couple the TEM horn antenna element 118 to the cavity at the grooves 114 to form the outer loop of the combined antenna 110. Although half-elliptical plates 122 are shown, they plate shapes are merely examples and other shapes are also contemplated.

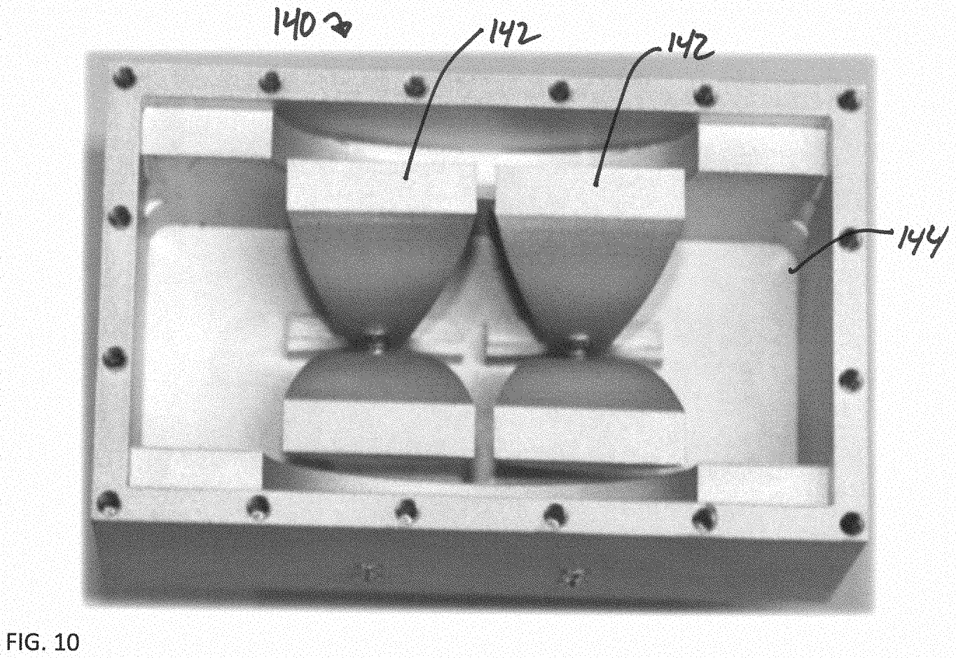

FIG. 10 shows an example implementation of a flush-mountable lossless combined array 140 in which two or more individual combined antennas are formed in a cavity 144 as described with respect to FIGS. 9A and 9B. The resulting combined antennas 110 and combined antenna arrays 140, for example, may be useful for applications such as high power delivery and long-range communications. In these implementations, for example, the antenna(s) 110, 142 is(are) recessed in a cavity and different geometrical parameters can be engineered to achieve one or more desired performance characteristic. See, e.g., M. Elmansouri and D. S. Filipovic, “Transient linear TEM horn arrays,” IET Microwaves, Antennas and Propagation, under review, incorporated by reference herein in its entirety.

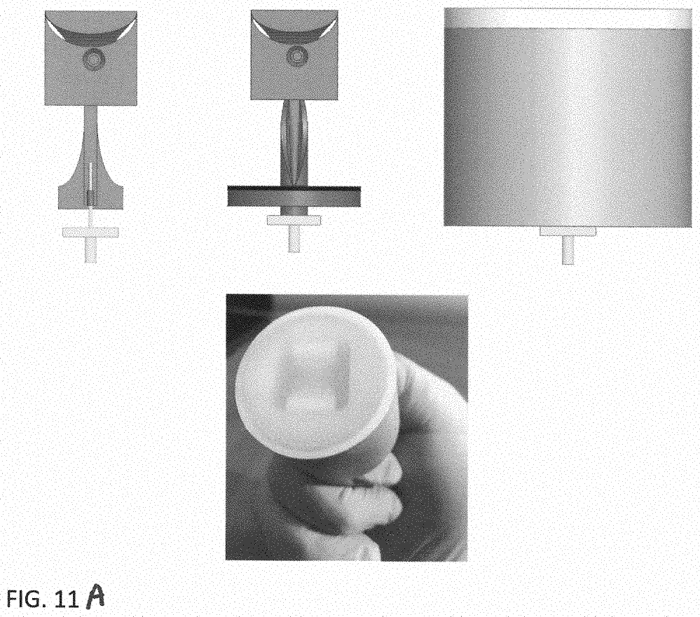

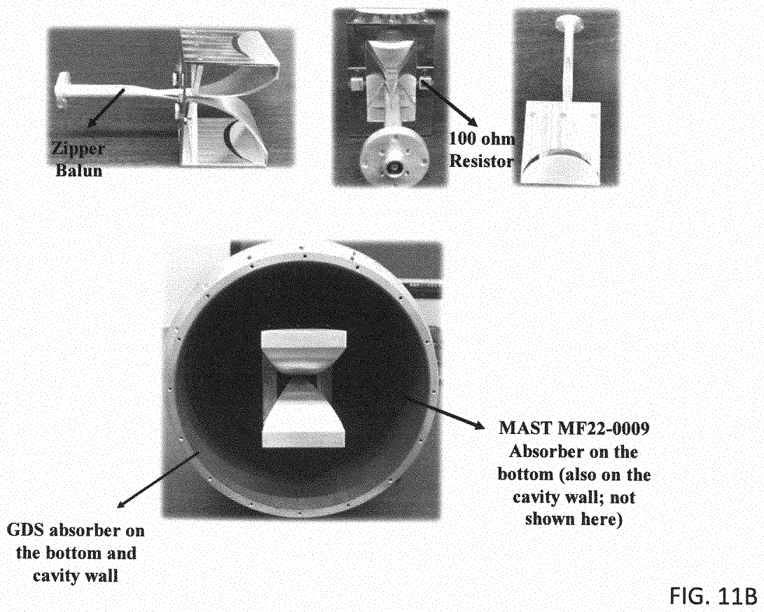

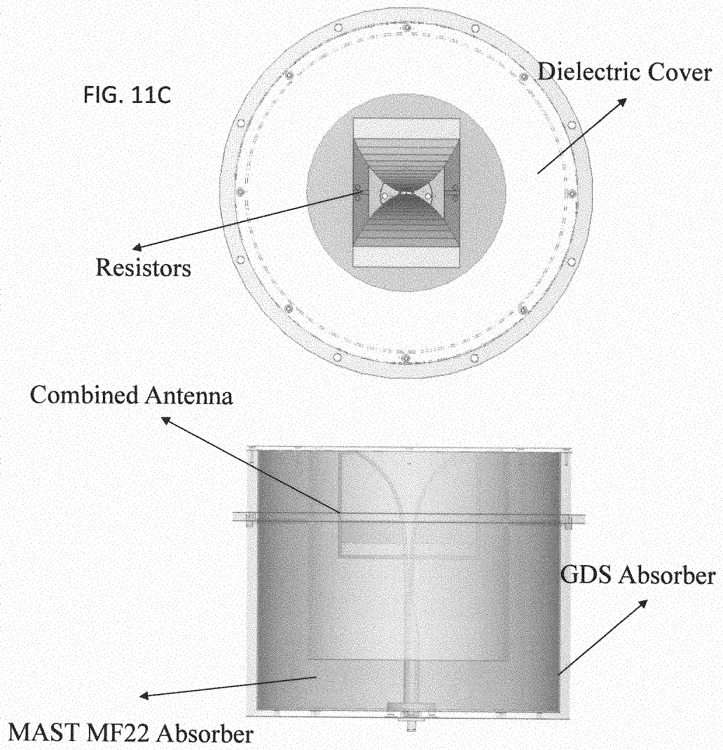

FIG. 11A shows example implementations of compact flush-mountable low-loss combined antenna 160 disposed in an absorptive cavity with radome for airborne decoy applications. In one example implementation, for example, the absorber type, cavity shape and dimensions, and balun geometry can be designed to maintain wide beams in wide field of view (FOV) over 10:1 bandwidth. FIGS. 11B and 11C show example implementations of the combined antenna 162 disposed within the absorptive cavity 164 to form the individual compact flush-mountable low-loss combined antenna 160.

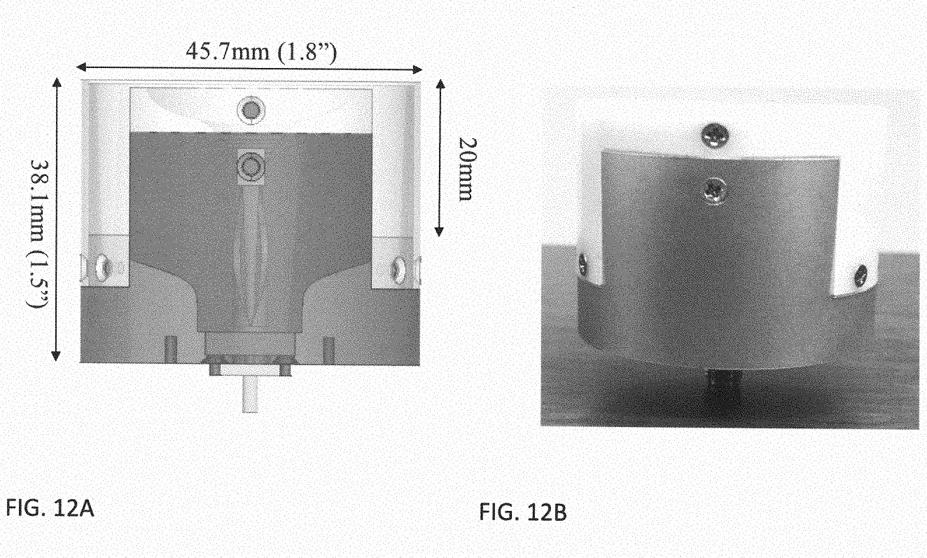

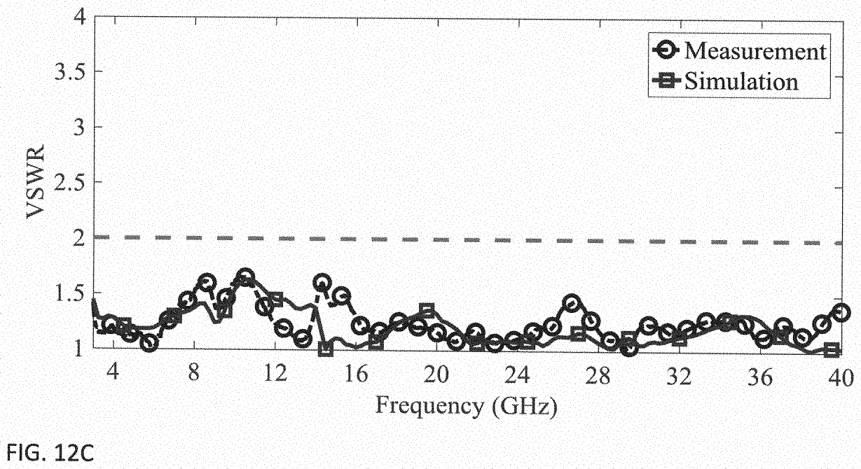

FIGS. 12A and 12B show example implementations of compact combined antennas 170 disposed in lossless cavity with radome for airborne decoy applications (FIG. 12A shows an example CAD model and FIG. 12B shows an example fabricated model). The metallic cavity shape and dimensions, and balun geometry are studied to maintain wide beams in wide field of view (FOV) over more than 10:1 bandwidth. Simple geometrical adjustments can be used to tune and improve the performance. For example, removing one bow-tie plate from one side of the antenna helps to improve VSWR and gain over up to ±60° FOV.

FIG. 12C shows a graph of the VSWR performance for a compact combined antenna in a lossless cavity with radome for airborne decoy applications.

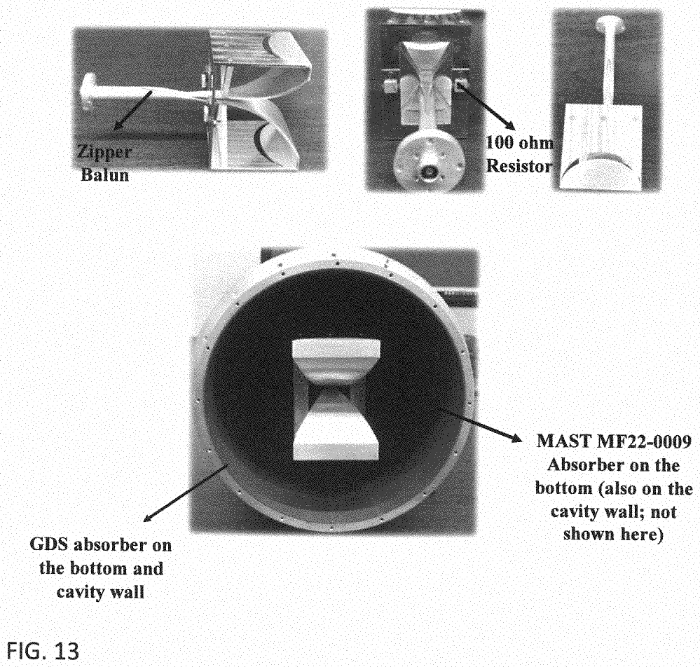

FIG. 13 shows an example compact resistively-loaded combined antenna with a zipper balun in an absorptive cavity that may be used in applications such as an amplitude-only direction finding application. The resistive termination is used to maintain good impedance match below the actual turn-on frequency of this antenna. Low reflectivity absorber is utilized in the cavity to eliminate any reflection from the cavity wall and maintain good quality radiation patterns with no ripples over 52:1 bandwidth (from 0.5 GHz to 26 GHz). Zipper balun is designed to achieve a smooth transition from the coaxial input to the parallel plate input at the TEM horn.

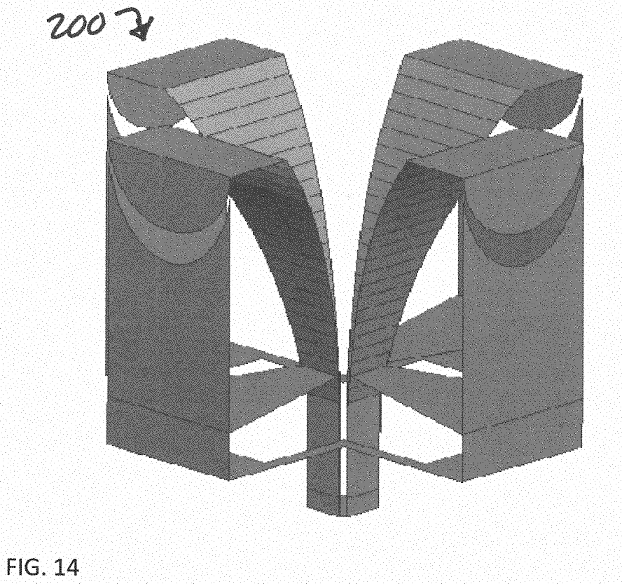

FIG. 14 shows an example implementation of a dual-polarized TEM horn combined antenna. In this particular implementation, for example, the combined antenna is adapted to achieve dual-polarization operation over multi-octave bandwidth. In particular, the combined antenna 200 includes four legs of the TEM horn antenna element and corresponding outer loop antenna elements.

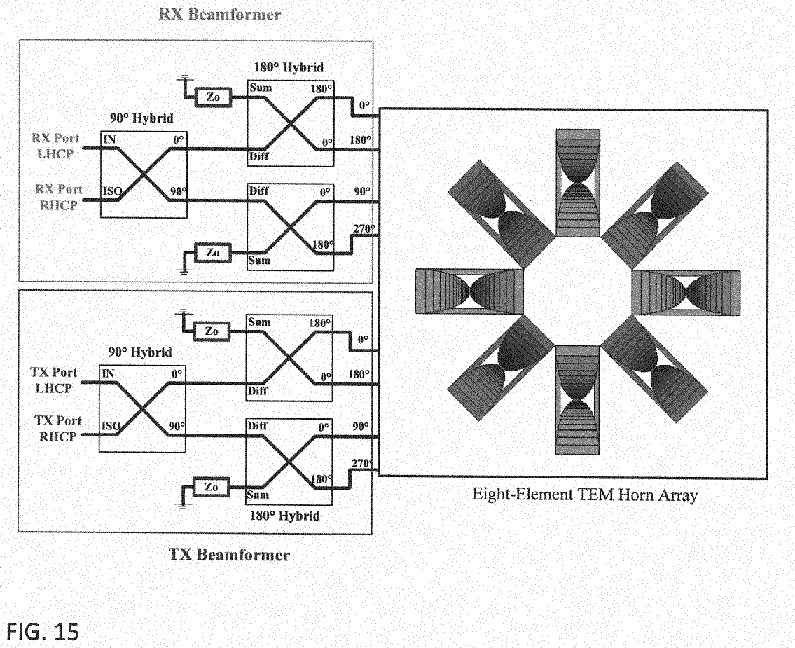

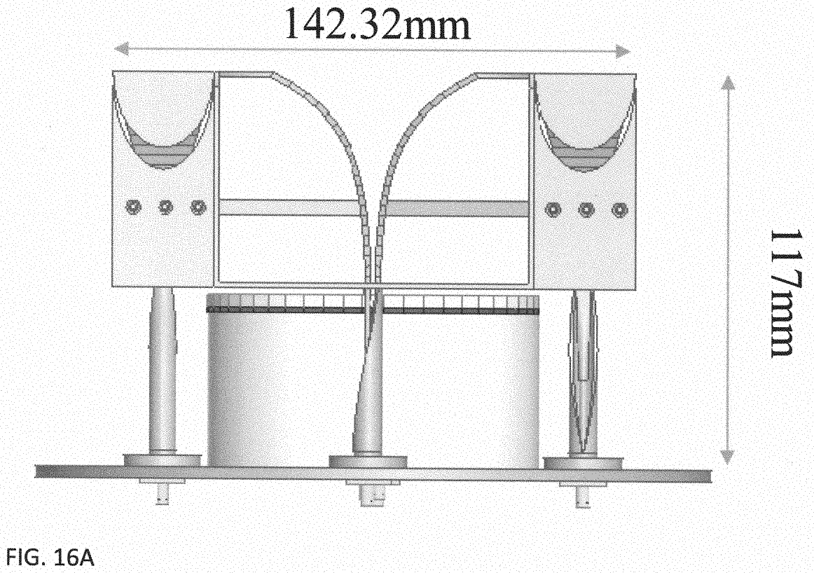

FIG. 15 shows a schematic diagram of an example eight-element combined antenna array (that may be free-standing or inside cavity) for simultaneous transmit and receive (STAR) applications. In one implementation, for example, four antenna elements of the array may be used for transmitting and the other four elements for receiving. Similarly other number of antenna elements other than the eight shown may be included in the array.

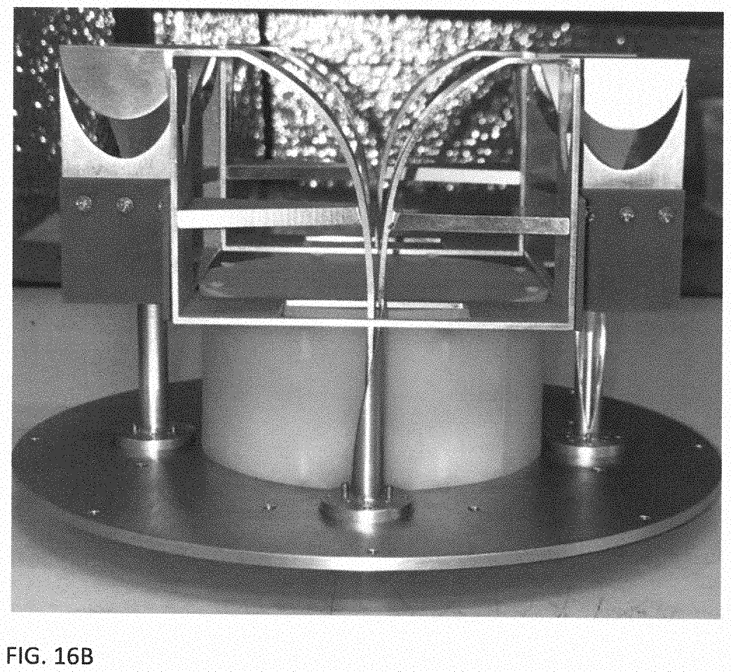

FIGS. 16A and 16B show example implementations of sequentially rotated array of four combined antennas combined with a four-arm sinuous antenna at the center of the array to realize a compact, wideband, and dual-polarized STAR antenna system. In one implementation, for example, the four-element array can be used for transmitting and the sinuous antenna for receiving. FIG. 16A shows a CAD depiction, and FIG. 16B shows an example of a fabricated model of the dual-polarized STAR antenna system.

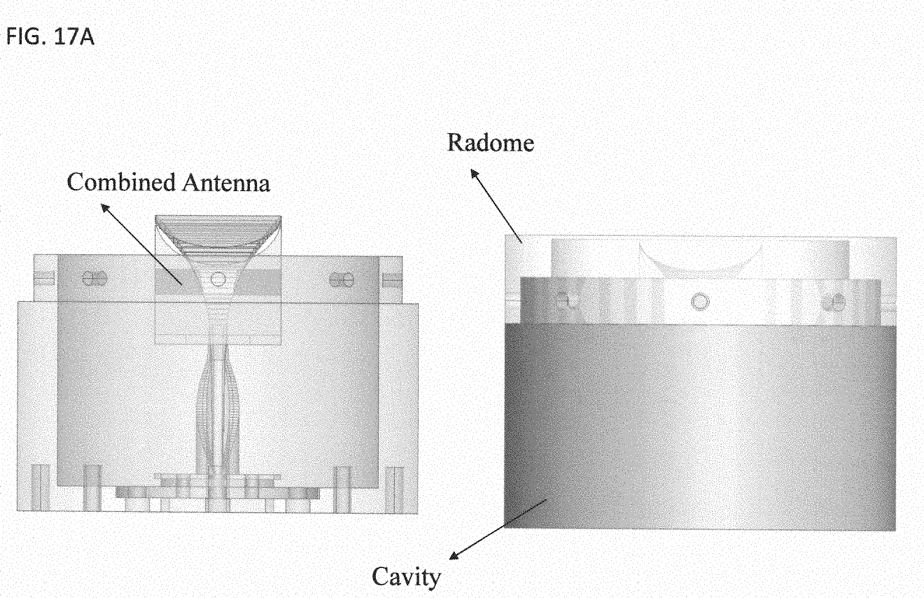

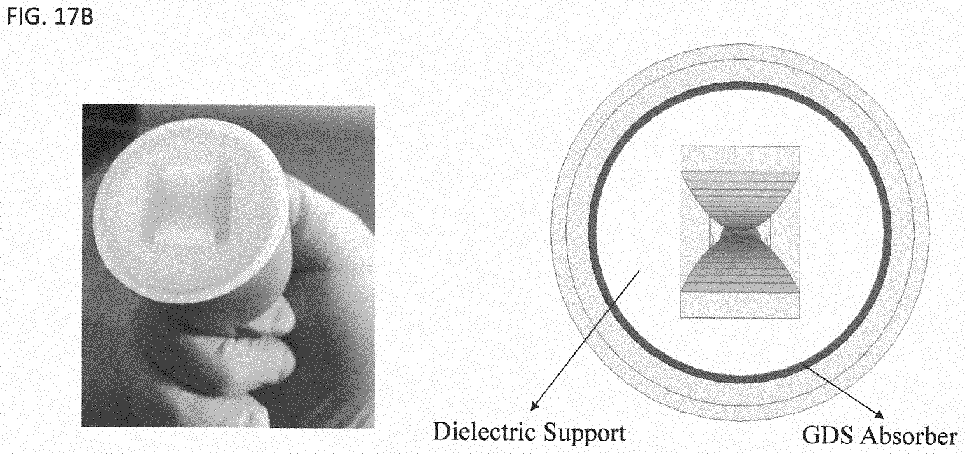

FIGS. 17A and 17B show another example implementation of a compact flush-mountable low-loss combined antenna in an absorptive cavity with radome for airborne decoy applications.

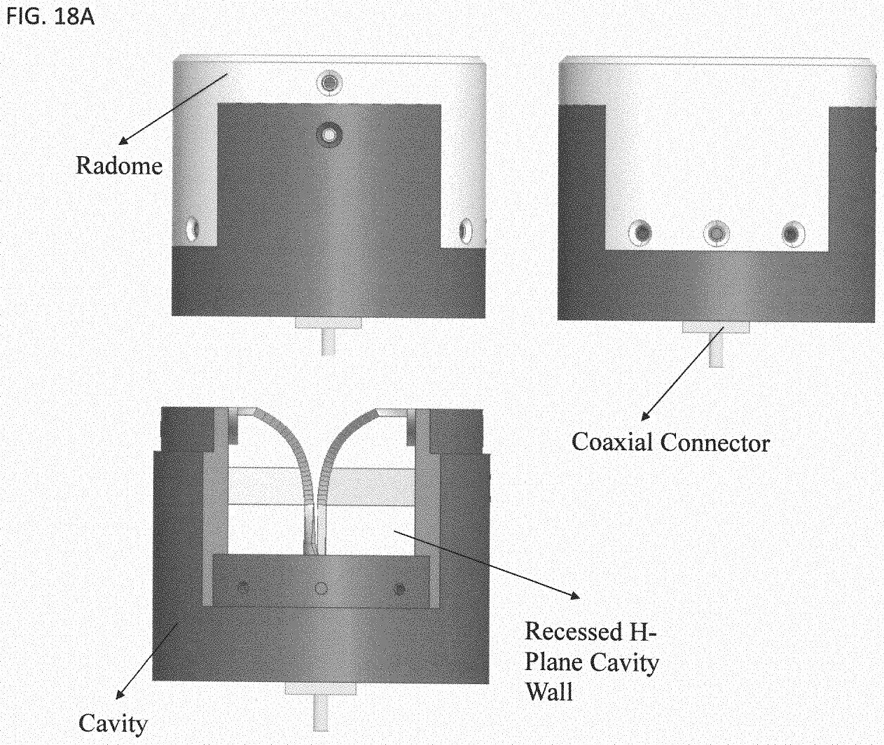

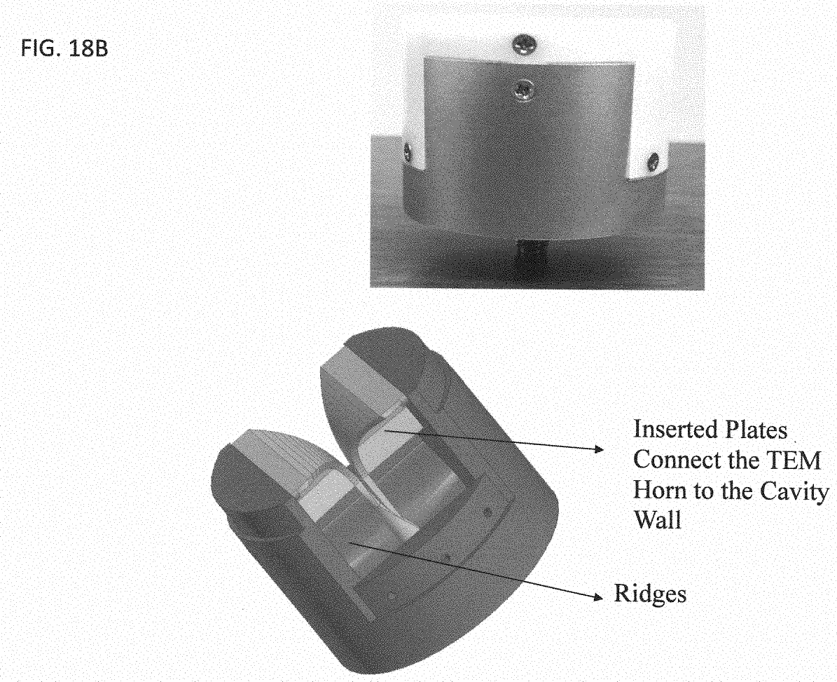

FIGS. 18A and 18B show another example implementation of a compact antenna in a loss-less cavity with radome for airborne decoy applications.

Although implementations have been described above with a certain degree of particularity, those skilled in the art could make numerous alterations to the disclosed embodiments without departing from the spirit or scope of this invention All directional references (e.g., upper, lower, upward, downward, left, right, leftward, rightward, top, bottom, above, below, vertical, horizontal, clockwise, and counterclockwise) are only used for identification purposes to aid the reader's understanding of the present invention, and do not create limitations, particularly as to the position, orientation, or use of the invention. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the spirit of the invention as defined in the appended claims.

What is claimed is:

1. A combined antenna comprising:
a transverse electromagnetic (TEM) horn antenna element; and a
a loop antenna element coupled to the TEM horn antenna element, wherein the loop antenna element comprises at least one slot disposed in the loop antenna element.

2. The combined antenna of claim 1 wherein the loop element comprises at least one plate disposed along a loop of the loop antenna element.

3. The combined antenna of claim 1 wherein the combined antenna is disposed within an array of antennas, such as an array of individual combined antenna elements.

4. A combined antenna comprising:
a first transverse electromagnetic (TEM) horn antenna element coupled to a first loop antenna element, the first loop antenna element comprises at least one slot disposed in the loop antenna element; and
a second TEM horn antenna element coupled to a second loop antenna element, the second loop antenna comprises at least one slot disposed in the loop antenna element.

5. The combined antenna of claim 4 wherein the loop element comprises at least one plate disposed along a loop of the loop antenna element.

6. The combined antenna of claim 4 wherein the combined antenna is disposed within an array of antennas, such as an array of individual combined antenna elements.

7. The combined antenna of claim 6 wherein the array comprises an array of individual combined antenna elements.

8. The combined antenna of claim 1 wherein the TEM horn element and the loop antenna element are mounted in a cavity.

9. The combined antenna of claim 1 wherein the loop antenna element is coupled to a ground plate.
